(19) United States
(12) Patent Application Publication
(10) Pub. No.: US 2013/0092494 A1
(43) Pub. Date: Apr. 18, 2013

(54) MULTI-POSITION ROTATING DEVICE AND UPRIGHT CUTLERY

(71) Applicants: Tony D. Scott, Weatherford, TX (US); James M. Cordell, Weatherford, TX (US); David Worley, Azle, TX (US)

(72) Inventors: Tony D. Scott, Weatherford, TX (US); James M. Cordell, Weatherford, TX (US); David Worley, Azle, TX (US)

(21) Appl. No.: 13/649,905

(22) Filed: Oct. 11, 2012

Related U.S. Application Data
(60) Provisional application No. 61/546,458, filed on Oct. 12, 2011.

(51) Int. Cl. F16D 11/00

(52) U.S. Cl. 192/46; 192/41 R

(57) ABSTRACT

An apparatus and a multi-position rotating device are disclosed herein. In one embodiment, the apparatus includes: (1) a main body having a rotational surface with a plurality of position holders and (2) an end cap releasably couplable to the main body and configured to rotate in a single direction, with respect to the rotational surface, based on the position holders.

### CROSS REFERENCE TO RELATED APPLICATION

This Application claims the benefit of U.S. Provisional Application Ser. No. 61/546,458 filed on Oct. 12, 2012, entitled “MULTI-POSITION ROTATING DEVICE AND UPRIGHT CUTLERY,” by Tony D. Scott, et al., which is incorporated herein by reference.

### TECHNICAL FIELD

This application relates to prosthetics and orthotics. More particularly, the application relates to improving the independence of individuals with mobility impairments and/or upper-limb impairments.

### BACKGROUND

Conventional amputee and mobility eating utensils are swivel type devices that make it difficult for an individual to feed themselves. For example, these conventional eating utensils prevent, or at least hinder, a user from securing food from a plate with a fork or spoon and then effectively transitioning the food from the plate to their mouths without some type of secondary assistance. Devices, systems or utensils that could improve the independence of individuals, such as allowing users to feed themselves, would be welcomed in the art.

### SUMMARY

In one aspect, the disclosure provides an apparatus. In one embodiment, the apparatus includes: (1) a main body having a rotational surface with a plurality of position holders and (2) an end cap releasably couplable to the main body and configured to rotate in a single direction, with respect to the rotational surface, based on the position holders.

In another aspect, the disclosure provides a multi-position rotating device. In one embodiment the multi-position rotation device includes: (1) a main body having a rotational surface with a plurality of position holders and a shaft tunnel, (2) a pivot shaft floatably positioned within the shaft tunnel and (3) an end cap mechanically fixed to the pivot shaft and releasably couplable to the main body, the end cap configured to rotate in only a single direction with respect to the rotational surface, wherein the single direction is determined by the plurality of position holders.

The disclosure also provides another embodiment of an apparatus. In this other embodiment, the apparatus includes: (1) a main body having a rotational surface with a plurality of position holders and (2) an end cap releasably couplable to said main body, wherein at least some of said plurality of position holders are configured to allow rotation of said main body in multiple directions with respect to said end cap.

### BRIEF DESCRIPTION OF THE DRAWINGS

For a more complete understanding of the present disclosure, reference is now made to the following descriptions taken in conjunction with the accompanying drawings, in which:

FIG. 1 illustrates a side view of an embodiment of a multi-position rotating device constructed according to the principles of the disclosure;

FIG. 2A illustrates a side view and a front view of an embodiment of a main body of the multi-position rotating device of FIG. 1;

FIG. 2B illustrates a diagram of an embodiment of the rotational surface of a main body constructed according to the principles of the disclosure;

FIG. 3 illustrates a side view and a top view of an embodiment of an end cap of the multi-position rotating device of FIG. 1;

FIG. 4 illustrates a side view of an embodiment of a pivot shaft of the multi-position rotating device of FIG. 1;

FIG. 5 illustrates an embodiment of various components used in the multi-position rotating device of FIG. 1;

FIG. 6A illustrates a side view of another embodiment of a multi-position rotating device constructed according to the principles of the disclosure; and

FIG. 6B illustrates a top view of the rotational surface of the main body of the multi-position rotating device in FIG. 6A.

### DETAILED DESCRIPTION

The disclosure provides embodiments of multiple-position rotating devices that can be employed by individuals to assist them in various tasks, such as feeding themselves. The multiple-position rotating device includes an adjustable, step rotation unit for active positioning of an end device. An end device is a device configured for a specific task or tasks that is couplable to the multiple-position rotating device. When coupled to the multi-positioning rotating device, a user can independently perform the various tasks. For example, the end device may be a fork, which can then be positioned via the multi-position rotating device to allow the individual to eat independently. The end device can be coupled to the multiple-position rotating device via a conventional means. In some embodiments, the end device is coupled to the multiple-position rotating device employing a non-permanent conventional means. For example, the end device can be bolted to the multiple-position rotating device. A conventional type of quick connector is another example of a non-permanent type of connector that can also be used for coupling the end device to the multiple-position rotating device. In another embodiment, the end device can be coupled to the multiple-position rotating device by a permanent connection, such as via a weld.

The multiple-position rotating device also includes an attacher that allows the application of different receiving couplings. The attacher allows the multiple-position rotating device to interface with various mounting structures including, but not limited to, prosthetic wrist units, adaptive bracing and an impaired extremity. The attacher can be coupled to various types of receiving couplings to allow universal mounting of the multiple-position rotating device. In one embodiment, the attacher is a threaded area for coupling to various receiving couplings of different mounting structures.

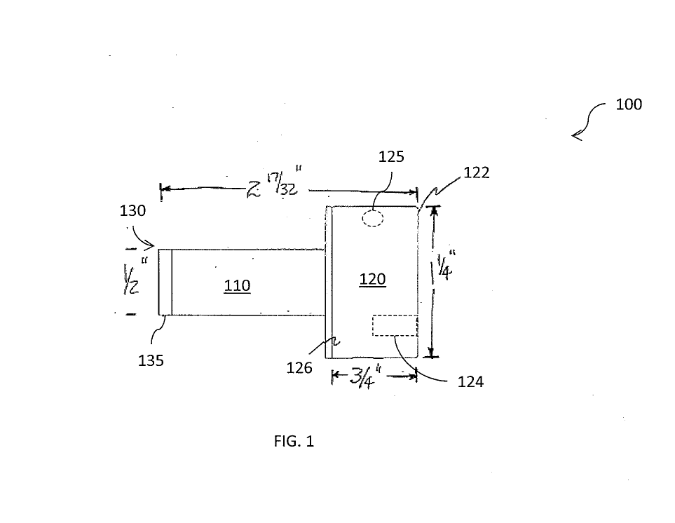

FIG. 1 illustrates a side view of an embodiment of a multi-position rotating device 100 constructed according to the principles of the disclosure. The multi-position rotating device 100 includes a main body 110, an end cap 120 and a pivot shaft 130. In FIG. 1, only a head 135 of the pivot shaft 130 is visible. In one embodiment, the multi-position rotating device 100 is made of steel. In another embodiment, the multi-position rotating device 100 is constructed of aluminum. One skilled in the art will understand that the multi-position rotating device 100 can be constructed of other rigid materials, also, including non-metals. In some embodiments, the multi-position rotating device 100, or at least a part thereof, can be constructed of a plastic or another type of moldable material. The finish of the multi-position rotating device 100 may also vary. For example, the finish for a metallic multi-position rotating device can be polished, anodized, or natural.

The multi-position rotating device 100 rotates in a single direction along a rotational line and holds a stable position at defined positions of the rotational line. The rotational line can correspond to a geometric shape such as a triangle, octagon, hexagon, etc. The rotational line can be an arc. In one embodiment disclosed herein the arc is a circle. In other embodiments, the arc can be an oval.

The defined positions are determined by position holders (not shown in FIG. 1) on a rotational surface (not shown in FIG. 1) of the main body 110. In some embodiments, each of the defined positions is equally spaced (including substantially equally spaced) apart along the rotational line. In other embodiments, the defined positions along the rotational line are not equally spaced.

Instead of a conventional swivel device, the multi-position rotating device 100 allows an end device connected thereto to be fixed at a stable position associated with one of the defined positions along the rotational line of the multi-position rotating device 100. A stable position is one of the defined positions wherein the end cap 120 or main body 110 is temporarily fixed from rotating. A non-stable position is when the end cap 120 is in between the defined positions. A sufficient rotational force is needed to move the end cap 120 from a stable position. Thus, when the end device is an eating utensil, users can feed themselves by placing the connected eating utensil at a particular position of their choosing from the multiple defined positions provided by the multi-position rotating device 100. To rotate to another stable position, the user can apply a sufficient rotational force to the end cap 120 (via the end device on the edge of a table, for example). A sufficient rotational force is the amount of rotational force needed to move a position selector discussed below out of or away from a position holder.

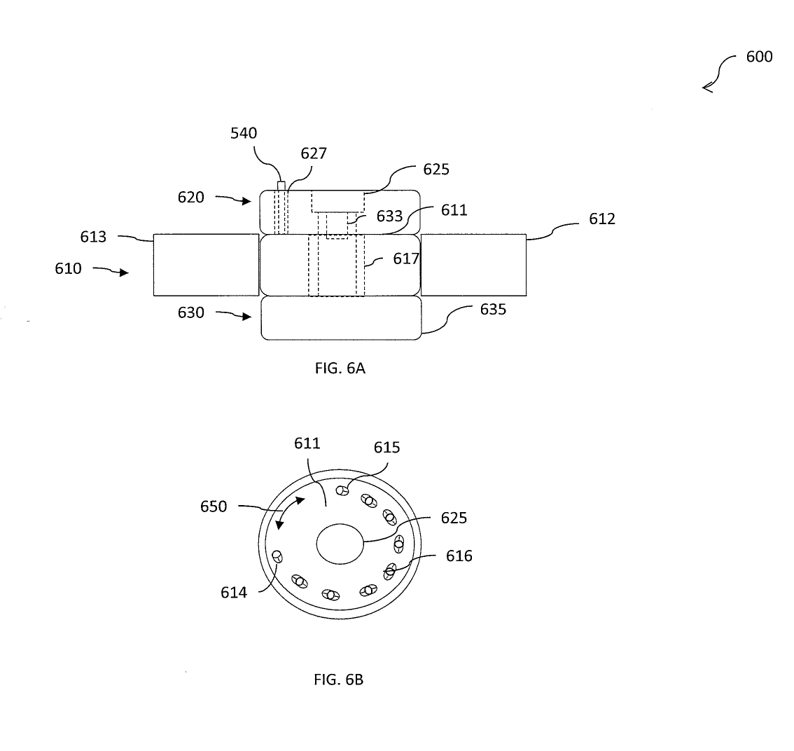

An end device, not illustrated in FIG. 1, is typically fixed to the end cap 120 at an outside face 122 of the end cap 120. In FIG. 1, a device receptor 124 receives an end device or a connecting component used to couple the end device to the end cap 120. In one embodiment, the device receptor 124 is a threaded hole configured to receive a bolt used to couple the end device to the end cap 120. As noted above, an end device can be attached using other means, also. The location of attachment can also vary in different embodiments. For example, an end device can also be connected along an outside surface 126 of the end cap 120. One attachment area, a device receptor 125, is denoted by the dashed circle on the outside surface 126 of the end cap 120. In some embodiments, such as illustrated in FIG. 6, an end device can be coupled to the main body of a multi-positioning rotating device. In one embodiment, more than one attachment area is included. Thus, the end cap 120 can include multiple device receptors as denoted by the device receptors 124 and 125. The type of attachments for end devices may be the same. In some embodiments, the various device receptors, such as device receptors 124, 125, are of different types. For example, a bolted connection can be used with a welded connection. In other embodiments, the device receptors 124, 125, can be of the same type. Each of the device receptors 124, 125, can be a conventional male or female connector. In some embodiments, the multi-position rotating device 100 could include two end devices spaced apart at different device receptors to allow a user to employ two different devices. For example, a user could use a fork and a spoon that are connected to the end cap 120 at the same time.

The size of the multi-position rotating device 100 can vary depending on the particular user. In some embodiments, the overall size of the multi-position rotating device 100 is smaller for use by a child. In other embodiments, the multi-position rotating device 100 is comparably larger for use by an adult. The multi-position rotating device 100 is also sized to correspond to the various mounting structures and end devices in which it will interact. FIG. 1 and the other figures provide dimensions for the illustrated embodiment of the multi-position rotating device 100. The dimensions in FIG. 1 and the corresponding Figures of the disclosure represent one embodiment of the multi-position rotating device 100 for an adult. One skilled in the art will understand that the dimensions can vary depending on application.

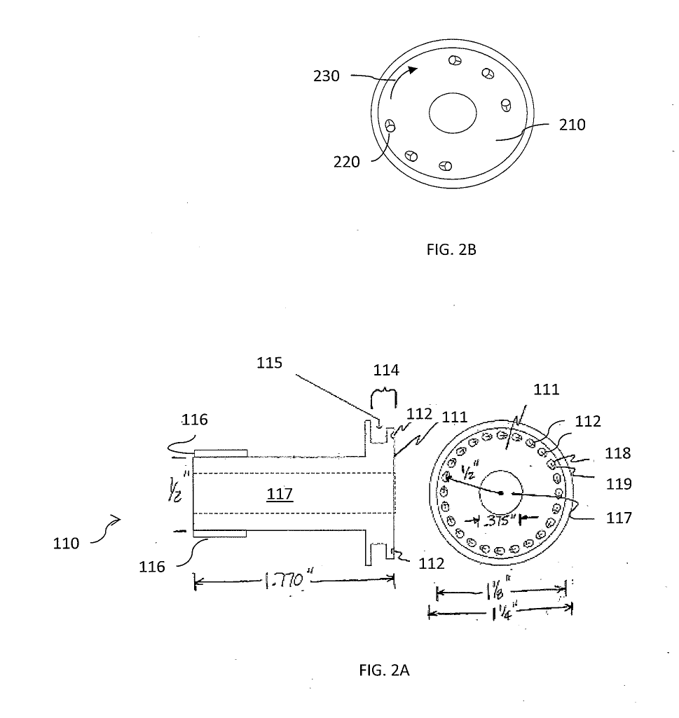

FIG. 2A illustrates a side and front view of the main body 110 of the multi-position rotating device 100. The main body 110 includes a rotational surface 111, position holders wherein a representative position holder is denoted 112, a sealing flange 114, a seal groove 115, an attacher 116 and a tunnel shaft 117. As illustrated in the front view of the main body 110, the rotational surface 111 includes multiple position holders 112. (Only two of the position holders 112 are illustrated in the side view of FIG. 2A to avoid confusion.) The position holders 112 are equally spaced along the rotational line of the rotational surface 111. The rotational line corresponds or follows the position holders 112. In FIG. 2A the rotational line is a circle. As noted above in some embodiments, the position holders are not equally spaced apart along the rotation line.

FIG. 2B illustrates one embodiment of a rotational surface 210 having position holders 220 that are irregularly spaced along a rotational line 230. The spacing of the position holders 220 along the rotational line 230 may be based on, for example, expected use, user size or user preferences.

The position holders 112 provide defined positions along the rotation arc that allow an end device connected thereto to be fixed at a stable position. In the illustrated embodiments of FIG. 2A and FIG. 2B, the position holders 112 are configured to cooperate with a position selector to provide the defined positions. In one embodiment, the position selector is a set screw. As such, each of the position holders 112 include an indent 118 that is sufficiently caved to receive the position selector and prevent rotation of the end cap 120 when the position selector is engaged with (sufficiently received into) the indent 118. The position holders 112 also include a ramp 119 on one side (i.e., the rotating side) of the indent 118 that allows the position selector to rotate out of an indent 118 in a single direction and along the rotational surface 111 of the main body 110 along the rotational line to the next position holder 112. A sufficient rotational force is needed to move the position selector out of or away from a position holder 112. The particular sufficient rotational force varies depending on such factors as the position holder (i.e., depth of indent slope of ramp, etc.) and the corresponding position selector.

In the illustrated embodiment of FIG. 2A, the rotational direction is clockwise. For counterclockwise rotation, a position holder would include a ramp on the opposite end of an indent. Thus, in one embodiment the ramp 119 and the indent 118 are configured to allow the end cap 120 to be rotated in only a single direction, a clockwise direction, along the rotational line and positioned at a defined position of one of the position holders 112 when the position selector is engaged therewith; thus arriving at a stable position.

In FIG. 2B the direction of rotation along the rotational line 230 is also clockwise based on the configuration of position holders 220. In both FIG. 2A and FIG. 2B there is a single rotation direction. In other embodiments, such as in FIG. 6, there are two directions of rotation (e.g., clockwise and counter clockwise). In these embodiments, the position holders or at least some thereof are configured to allow rotation in at least two directions. For example, a position holder can include two ramps with an indent to allow rotation in the two directions defined by the ramps.

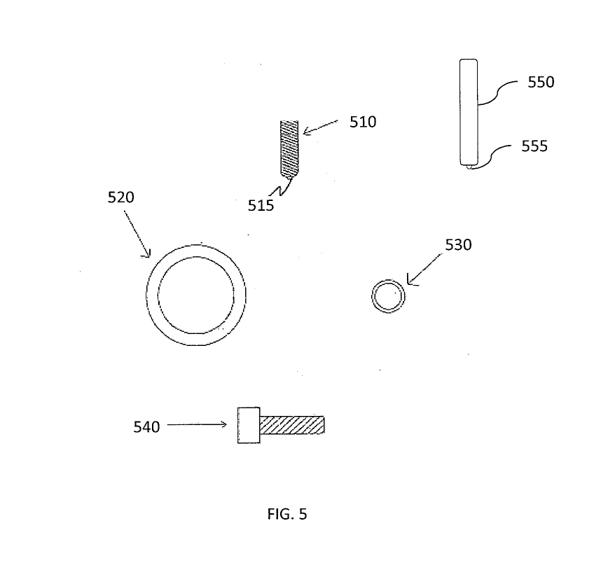

An embodiment of a set screw used for a position selector, set screw 510, is illustrated in FIG. 5 and discussed below. In some embodiments, a position selector can be a conventional “push button” selector. FIG. 5 also includes such a position selector, push button selector 550.

The rotational surface of the main body 110 includes 24 position holders 112 wherein one represented position holder 112 is identified with the indent 118 and the ramp 119. The indent 118 has a depth and width of or about 0.042 inches and 0.078 inches, respectively. The ramp 119 starts at the bottom of the indent 118 and ramps up to the rotational surface 111 of the main body 110. The set screw 510 for the multi-position rotating device 100 is a detent set screw that includes a spring loaded ball 515 at the end. As such, the indent 118 is sized to cooperate with the spring loaded ball 515 to allow rotation of the end cap 120 in a single direction with respect to the main body 110 and allow the end cap 120 to be placed at defined positions that correspond to the position holders 112. The size of the indent 118 and ramp 119 corresponds to the size of a position holder (e.g., the size of a spring loaded ball) employed. Thus, size of the indent 118 and ramp 119 can vary. Additionally, the number of position holders 112 and spacing in between can vary.

The sealing flange 114 is configured to interact with a gasket to provide a sealed, rotatable connection that can be lubricated. The sealing flange 114 includes a seal groove 115 that is configured to receive a gasket. In FIG. 2A, the seal groove 115 is a machined groove for receiving and holding an o-ring. The seal groove 115 is configured for an o-ring having a 0.875 inch ID and a 1¼ inch OD. In FIG. 5, an o-ring 520 is illustrated that can be used with the seal groove 115. One skilled in the art will understand that other types of gaskets can be used instead of an o-ring and that the sealing flange 114 and seal groove 115 can be configured for different sizes of gaskets or o-rings. Conventional gaskets or o-rings can be employed in the illustrated embodiment.

The main body 110 also includes an attacher 116 that is configured to couple the multi-position rotating device 100 to other devices, such as prosthetic limbs. In FIG. 2A the attacher 116 is a threaded area to provide a male attachment for a female receptacle of another device. The threaded area is threaded for attaching with about a ½ inch area of threads along the length of the attacher 116. In one embodiment, the attacher 116 has ½-20 threads for attaching to conventional prosthetic limbs in the U.S. The diameter of the attacher 116 and the thread type can vary in different embodiments to correspond to various standard coupling devices. For example, the diameter and thread type may be configured to correspond to European prosthetic limb standards. Thus, the attacher 116 can be sized and shaped to comply with various attachment standards throughout the world.

For example, in other embodiments, the attacher 116 can be configured to couple with devices employing a quick-disconnect connection or other conventional coupling mechanisms. One skilled in the art will understand that a quick-disconnect connection includes a sleeve with ball bearings that allows the attacher 116 to snap into place. For this type of connection, the outer diameter of the attacher 116 may be ⅝ inch. The attributes of the attacher 116, including the diameter, length and shape, can vary to connect to designated receivers. The configuration of the attacher 116 can also vary. For example, the attacher 116 is a male device that couples with a type of female device. In some embodiments, at least a portion of the attacher 116 may be a female device that is configured to couple to a male receiving device. In one embodiment, the attacher 116 is configured to connect to multiple types of connections. For example, the attacher 116 can be a threaded area and also be configured with a disconnect connection wherein the threaded area is located on the outside of the sleeve. Thus, a single embodiment can be configured for multiple types of connections.

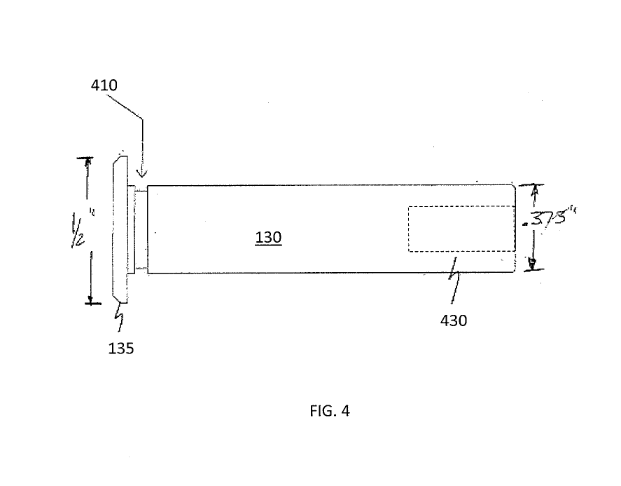

The main body 110 includes a hollow volume in the center to provide a shaft tunnel 117 for the pivot shaft 130 to pass through. The pivot shaft 130 is more fully illustrated in FIG. 4. The pivot shaft 130 is mechanically fastened to the end cap 120. In one embodiment, a cap screw is used to mechanically fasten the pivot shaft 130 to the end cap 120. An example of a cap screw 540 is illustrated in FIG. 5. The diameter of the pivot shaft 130 is less than the diameter of the shaft tunnel 117 such that the pivot shaft 130 can rotate freely within the shaft tunnel 117 of the main body 110 when affixed to the end cap 120. As such, the pivot shaft 130 floats within the shaft tunnel 117 as it rotates.

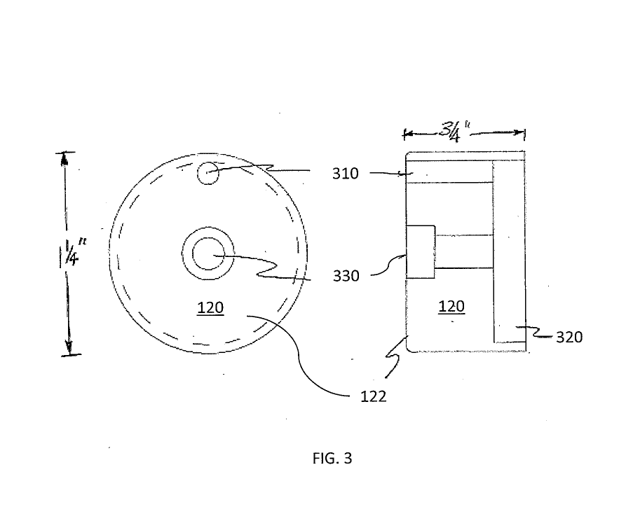

FIG. 3 illustrates a side view and a front view of the end cap 120 of the multi-position rotating device 100. The side view is a cut-away view of the end cap 120. As noted above, the end cap 120 is mechanically connected to the pivot shaft 130 illustrated in FIG. 4. In one embodiment, the end cap 120 is bolted to the pivot shaft 130, which slides through the shaft tunnel 117 of the main body 110, with the cap screw 540 that is placed through a fixed connection opening 330 of the end cap 120. A position selector, such as the set screw 510, installs in the selector receiver 310 on the outside face 122 of the End Cap 130 and protrudes through on the inside of the End Cap 130 to interact with the position holders 112 on the rotational surface 111 of the main body 110. In one embodiment, the selector receiver 310 is a threaded hole configured to receive a set screw, such as set screw 510. As such, in one embodiment the set screw 510 is positioned such that the spring loaded ball 515 at the end thereof can select the defined positions when inserted in the position holders 112 and still rotate out of the indent 118 up the indent ramp 119. This allows the end cap 120 to be releasably coupled to the main body 110 and rotation of the multi-position rotating device 100 in a direction defined by the position holders 112. A lubricating fluid, such as an industrial grade lubricant, may be employed to assist in the rotation movement. The lubricating fluid is located contained in the space between the pivot shaft 130 and the main body 110 and between the rotational surface 111 of the main body 110 and a receiving area 320 of the end cap 120. The space between the pivot shaft 130 and the main body 110 is sufficient to allow free rotation (i.e., rotation without the pivot shaft 130 and the main body 110 touching). In FIG. 3, the receiving area 320 is a counter bore area configured to receive the sealing flange 114 of the main body 110. The o-ring 520 of FIG. 5 and the o-ring of the pivot shaft 130, o-ring 530 illustrated in FIG. 5, are employed to keep the lubricating fluid within the multi-position rotating device 100.

FIG. 4 illustrates a side view of the pivot shaft 130 of the multi-position rotating device 100. The pivot shaft 130 has a shaft groove 410 configured to receive and hold a gasket, such as the o-ring 530. In FIG. 4 the shaft groove 410 is a machined groove sized to receive a designated gasket, such as the o-ring 530. The o-ring 530 completes the seal of the assembled unit, the assembled multi-position rotating device 100. In the illustrated embodiment, the o-ring 530 (i.e., pivot shaft o-ring) has a 0.330 inch ID and a 0.375 inch OD. The pivot shaft 130 has a coupling receiver 430 in the end opposite of the shaft groove 410 for a mechanical connection and for assembly of the multi-position rotating device 100. In the illustrated embodiment, the coupling receiver 430 is a threaded hole configured to receive the cap screw 540. The pivot shaft 130 slides through the center of the main body 110 (i.e., through the shaft tunnel 117) and bolts to the end cap 120 with the cap screw 530 that is positioned through the fixed connection opening 330 and into the coupling receiver 430. This locks the multi-position rotating device 100 together and allows for rotation and defined positioning. In the illustrated embodiment, the threaded hole of the coupling receiver 430 and cap screw 530 have 10-32 threads. The opposite end of the pivot shaft 130 from the coupling receiver 430, wherein the shaft groove 410 is located, also includes the head 135. For the multi-position rotating device 100, head 135 has a diameter which corresponds to the diameter of the attacher 116. The head 135 is visible in FIG. 1. The length of the pivot shaft 130 corresponds to the length and size of the main body 110 and the end cap 120, wherein the pivot shaft 130 (except for the head 135) is within the main body 110 and the end cap 120.

FIG. 5 illustrates a side view of an embodiment of a position selector, the detent set screw 510 of the multi-position rotating device 100. The detent set screw 510 inserts within the corresponding selector receiver 310, which in this embodiment is a threaded hole of the end cap 120, and fits within the position holders 112 of the main body 110 to provide stable positions at the defined positions provided by the position holders 112. The detent set screw 510 includes a spring loaded ball 515 that engages with the position holders 512. The width of the spring loaded ball 515 is 0.070 inches. The detent set screw 510 and corresponding selector receiver 310 have an 8-32 thread pattern.

FIG. 5 also illustrates a top view of an embodiment of an o-ring, o-ring 520 for the main body 110 of the multi-position rotating device 100. This o-ring 520 assists with interfacing between the end cap 120 and the main body 110. The main body 110 o-ring fits within the seal groove 115 and is positioned within the receiving area 320 of the end cap 120 in an assembled multi-position rotating device 100.

FIG. 5 also illustrates a top view of an embodiment of the o-ring, o-ring 530 for the pivot shaft 130 of the multi-position rotating device 100. The o-ring 530 seals the main body 110 at the end of the main body 110 opposite the end cap 120. The pivot shaft o-ring 530 fits within the shaft groove 410 and is within main body 110 in an assembled multi-position rotating device 100.

FIG. 5 illustrates a side view of an embodiment of a cap screw 540 for the end cap 120 of the multi-position rotating device 100. The cap screw 540 screws into the threads of the coupling receiver 430 in the center of the pivot shaft 130. As such, the pivot shaft 130 floats within the main body 110.

The push button selector 550 is also illustrated in FIG. 5. The push button selector 550 includes a spring loaded ball 555 that engages with position holders such as the spring loaded ball 515. The push button selector 550 can be employed in embodiments where a stronger stable position is needed. In other words, a greater rotational force would be required to rotate away from or out of a position holder. A user, therefore, would be required to push the push button selector 550 to release the spring loaded ball 555 before rotation out of position holder. FIG. 6 illustrates an embodiment employing a the push button selector 550 as a position selector.

FIG. 6A illustrates a side view (a cut away view) of another embodiment of a multi-position rotating device 600 constructed according to the principles of the disclosure. Though sized or oriented differently, the multi-position rotating device 600 includes similar components as the multi-position rotating device 100 and provides at least the rotational functionality as described above with the multi-position rotating device 100. As such, the various similar components in FIG. 6 may be constructed as described above with respect to the multi-position rotating device 100. One skilled in the art will understand the specific connection details that can be used (such as gaskets, flanges, etc.) between the various components of the multi-position rotating device 600 in view of FIGS. 1-5.

The multi-position rotating device 600 includes a main body 610, an end cap 620 and a pivot shaft 630 having a head 635. A shaft of the pivot shaft 630 (represented by the dashed lines) is positioned through a tunnel shaft 617 of the main body 610. The pivot shaft 630 includes a coupling receiver 633 upon which the pivot shaft 630 can be mechanically fixed to the end cap 620 by a cap screw that is positioned through a fixed connection opening 625 of the end cap 620. A selector receiver 627 of the end cap 620 is configured to receive the position selector 540 that is configured to interact with a rotational surface 611 of the main body 610. Other types of position selector can be employed in different embodiments.

In addition to the rotational surface 611, the main body 610 includes a device receptor 612 and an attacher 613. As with the device receptor 124 or 125 and the attacher 116 of the multi-position rotating device 100, the device receptor 612 and an attacher 613 are configured to couple the multi-position rotating device 600 to an end device and a mounting structure, respectively. As such, the device receptor 612 and the attacher 613 can be similarly configured.

FIG. 6B illustrates a top view of the rotational surface 611 of the main body 610 of the multi-position rotating device 600 in FIG. 6A. The rotational surface 611 includes a position holder 614, a position holder 615 and multiple other position holders in which one is identified as position holder 616. Position holders 614 and 615 include an indent and a single ramp that allows rotation in one direction. Position holder 614 allows rotation in a counter clockwise direction and position holder 615 allows rotation in a clockwise direction. In contrast, position holder 616 includes an indent and two ramps that allow rotation in two different directions as indicated by rotational line 650. As such, position holders 614 and 615 are configured and positioned to provide rotational stops. The position holders 614, 615, can be positioned to provide a particular range of rotation that can be based on particular applications of the device 600.

In some embodiments, the rotational surfaces described herein can be removable (i.e., not integral to a main body) and semi-permanently fixed to a main body by, for example, a mechanical connection. As such, different rotational surfaces can have different rotational characteristics including rotational range, number of rotation directions, number of position holders and spacing between position holders. Additionally, different type of position holders can be used on the different rotational surfaces. For example, the depth of an indent can be changed to increase or decrease the force needed for rotation. This can allow a user to change to a stronger multi-position rotating device if desired. In some embodiments, a rotational surface can be constructed of one material and the main body can be constructed on another material. For example, the rotational surface can be made of a metal wherein the main body and other components are formed from a moldable plastic (i.e., a mold is used).

Although the disclosure has been described in detail, those skilled in the art should understand that they can make various changes, substitutions and alterations herein without departing from the spirit and scope of the invention in its broadest form. One skilled in the art will understand that the dimensions disclosed herein can be modified for different embodiments. Additionally, one skilled in the art will understand the scope of the disclosure includes manufacturing the various components disclosed herein. In one embodiment, the various components may be machined or molded.

1. An apparatus, comprising:
a main body having a rotational surface with a plurality of position holders; and
an end cap releasably couplable to said main body and configured to rotate in a single direction, with respect to said rotational surface, based on said position holders.

2. The apparatus as recited in claim 1 wherein said main body has a shaft tunnel, said apparatus further comprising a pivot shaft positioned within said shaft tunnel and mechanically fixed to said end cap.

3. The apparatus as recited in claim 1 wherein said pivot shaft is mechanically fixed to said end cap by a screw.

4. The apparatus as recited in claim 1 wherein said main body includes an attacher configured to connect said apparatus to at least one type of mounting structure.

5. The apparatus as recited in claim 1 wherein each of said position holders includes an indentation and a ramp, wherein said single direction of rotation is determined by said ramp.

6. The apparatus as recited in claim 1 further comprising a position selector configured to interact with said position holders to provide a stable position of said end cap at defined positions determined by said position holders.

7. The apparatus as recited in claim 6 wherein said position selector is a detent set screw.

8. The apparatus as recited in claim 1 wherein said position holders are located along an arc on said rotational surface.

9. The apparatus as recited in claim 1 wherein said position holders are equally spaced apart on said rotational surface.

10. The apparatus as recited in claim 1 wherein said end cap includes a device receptor configured to connect an end device to said end cap.

11. The apparatus as recited in claim 1 wherein at least some of said position holders are located in a line on said rotational surface.

12. A multi-position rotating device, comprising:
a main body having a rotational surface with a plurality of position holders and a shaft tunnel;
a pivot shaft floatably positioned within said shaft tunnel; and
an end cap mechanically fixed to said pivot shaft and releasably couplable to said main body, said end cap configured to rotate in only a single direction with respect to said rotational surface, wherein said single direction is determined by said plurality of position holders.

13. The multi-position rotating device as recited in claim 12 wherein each of said position holders includes an indentation and a ramp, wherein said single direction of rotation is determined by said ramp.

14. The multi-position rotating device as recited in claim 13 further comprising a position selector configured to interact with said indent and ramp to provide a stable position of said end cap at defined positions determined by said position holders.

15. The multi-position rotating device as recited in claim 14 wherein said position selector is a detent set screw.

16. The multi-position rotating device as recited in claim 13 wherein said position holders are located along an arc on said rotational surface.

17. The multi-position rotating device as recited in claim 13 wherein said position holders are equally spaced apart on said rotational surface.

18. The multi-position rotating device as recited in claim 12 wherein said main body includes an attacher configured to connect said apparatus to at least one type of mounting structure.

19. The multi-position rotating device as recited in claim 12 wherein said end cap includes a device receptor configured to connect an end device to said end cap.

20. An apparatus, comprising:
a main body having a rotational surface with a plurality of position holders; and
an end cap releasably couplable to said main body, wherein at least some of said plurality of position holders are configured to allow rotation of said main body in multiple directions with respect to said end cap.
